(19) United States
(12) Patent Application Publication
(10) Pub. No.: US 2013/0314347 A1
(43) Pub. Date: Nov. 28, 2013

(54) TOUCH PANEL AND INPUT DEVICE USING SAME

(71) Applicant: Panasonic Corporation, Osaka (JP)

(72) Inventors: Keisyu MURAOKA, Osaka (JP); Tamotsu YAMAMOTO, Hyogo (JP)

(73) Assignee: PANASONIC CORPORATION, Osaka (JP)

(21) Appl. No.: 13/895,204

(22) Filed: May 15, 2013

(30) Foreign Application Priority Data
May 25, 2012 (JP) 2012-119670

(51) Int. Cl. H01H 9/02

(52) U.S. Cl. CPC H01H 9/02
USPC 345/173; 200/600

(57) ABSTRACT

A touch panel includes a first substrate, multiple translucent first electrodes, multiple first wirings, a second substrate, multiple translucent second electrodes, multiple second wirings, and a light-shielding layer. The first wirings include first ends connected to the respective first electrodes, and second ends extending to the edge of the first substrate. The second wirings include first ends connected to the respective second electrodes, and second ends extending to the edge of the second substrate. The light-shielding layer is formed on the first substrate in a position covering at least a part of the first wirings and also corresponding to at least a part of the second wirings.

### TECHNICAL FIELD

The present technical field relates to a touch panel and an input device using, the same.

### BACKGROUND ART

In recent years, equipment such as mobile phones and car navigation units employs an input device that includes a translucent capacitive touch panel mounted on the display face of a display device, such as a liquid crystal display, for switching between the equipment's functions. In this type of touch panel, multiple metal wirings are connected to multiple transparent first electrodes and multiple transparent second electrodes, respectively. A predetermined voltage is applied between the first electrodes and the second electrodes via these metal wirings. To improve the appearance of the touch panel, there is a need to make the wirings connected to the first electrodes and second electrodes less visible to the user.

FIG. 5 is a sectional view of conventional input device 20. To facilitate understanding of its structure, dimensions in the thickness direction are expanded. Input device 20 includes casing 1, transparent plate 2, touch panel 3, and display device 4.

Transparent plate 2 is disposed in opening 1A of casing 1. Touch panel 3 is disposed between transparent plate 2 and display device 4. The base material of transparent plate 2 is a transparent glass, insulating resin or the like. Decorative layer 5 is disposed in non-operating area S2 surrounding operating area S1 of transparent plate 2. Decorative layer 5 is configured with non-translucent ink or the like. Touch panel 3 includes first substrate 11, second substrate 12, cover layer 13, and multiple adhesion layers 14.

First substrate 11 is a translucent film. Multiple belt-like translucent first electrodes 15, made of indium tin oxide or the like, are formed on the top face of first substrate 11. Each of first electrodes 15 is connected to the first end of first wiring 16 made of metal. The second end of first wiring 16 extends to the edge of first substrate 11.

Second substrate 12 is a translucent film. Multiple belt-like translucent second electrodes 17, made of indium tin oxide or the like, are formed on the top face of second substrate 12 in a direction perpendicular to first electrodes 15. Second electrodes 17 are connected to the first ends of second wirings 18. The second end of second wiring 18 extends to the edge of second substrate 12.

Cover layer 13 is a translucent film. Adhesion layer 14 is formed of acrylic adhesive material or the like. Cover layer 13 is the bottom layer of touch panel 3. Adhesion layer 14 is provided on the top face of cover layer 13 to bond cover layer 13 and second substrate 12. Adhesion layer 14 is also provided on the top face of second substrate 12 to bond second substrate 12 and first substrate 11. Adhesion layer 14 is also provided on the top face of first substrate 11. This configures touch panel 3.

Touch panel 3 is fixed to the bottom face of transparent plate 2 by adhesion layer 14. Decorative layer 5 is formed on an upper part of transparent plate 2 in a position corresponding to first wirings 16 and second wirings 18.

Display device 4 is a liquid crystal display or the like that displays icons and the like in operating area S1 to direct the user to operate the equipment using the top face of transparent plate 2.

When the user touches the top face of transparent plate 2, according to what is displayed on display device 4, the electric field detected in touch panel 3 changes and thus the display on display device 4 changes.

### SUMMARY

A touch panel includes a first substrate, multiple translucent first electrodes, multiple first wirings, a second substrate, multiple translucent second electrodes, multiple second wirings, and a light-shielding layer. The first electrodes are formed on the first substrate in a first direction. The first wirings include first ends connected to the respective first electrodes and second ends extending to the edge of the first substrate. The second substrate is disposed below the first substrate. The second electrodes are formed on the second substrate in a second direction perpendicular to the first electrodes. The second wirings include first ends connected to the respective second electrodes and second ends extending to the edge of the second substrate. The light-shielding layer is formed on the first substrate in a position covering at least a part of the first wirings and also corresponding to at least a part of the second wirings.

### BRIEF DESCRIPTION OF THE DRAWINGS

FIG. 1 is a sectional view of a touch panel in accordance with an exemplary embodiment.

FIG. 2 is an exploded perspective view of the touch panel in accordance with the exemplary embodiment.

FIG. 3 is a sectional view of an input device using a touch panel in accordance with the exemplary embodiment.

FIG. 4 is a sectional view of an input device using another touch panel in accordance with the exemplary embodiment.

FIG. 5 is a sectional view of a conventional input device.

### DETAILED DESCRIPTION

A recent manufacturing method of input devices adopts the in-mold process for molding a transparent plate and casing, using molds, and making prints on the surface at the same time, for example. In the in-mold process, a decorative layer may be provided on the transparent plate on a face opposite to that facing the display device.

In conventional input device 20 as configured above, however, there is a long distance between decorative layer 5 and first wirings 16 and between decorative layer 5 and second wirings 18. This permits the user to see first wirings 16 or second wirings 18, thus degrading the appearance of input device 20.

One of methods of making first wirings 16 and second wirings 18 difficult to see is to broaden decorative layer 5. However, if decorative layer 5 is broadened, the display area of display device 4 becomes narrow. Or, if the display area is broadened, the outer shape of the input device becomes larger.

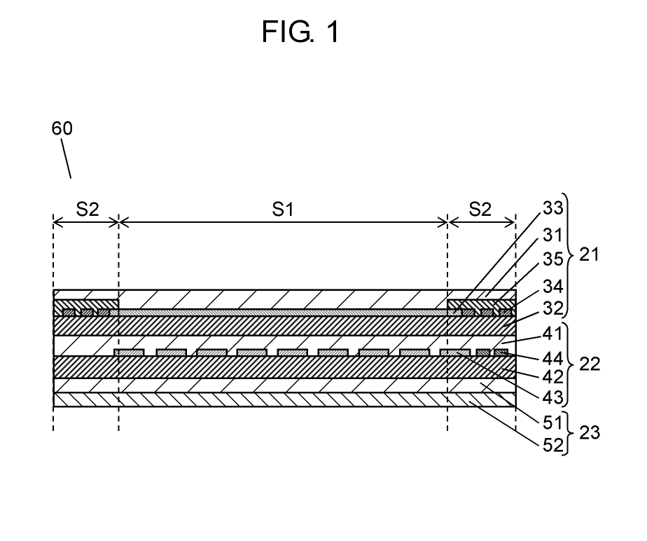

An exemplary embodiment is described below with reference to FIGS. 1 to 4. To facilitate understanding of the structure, dimensions are partly expanded.

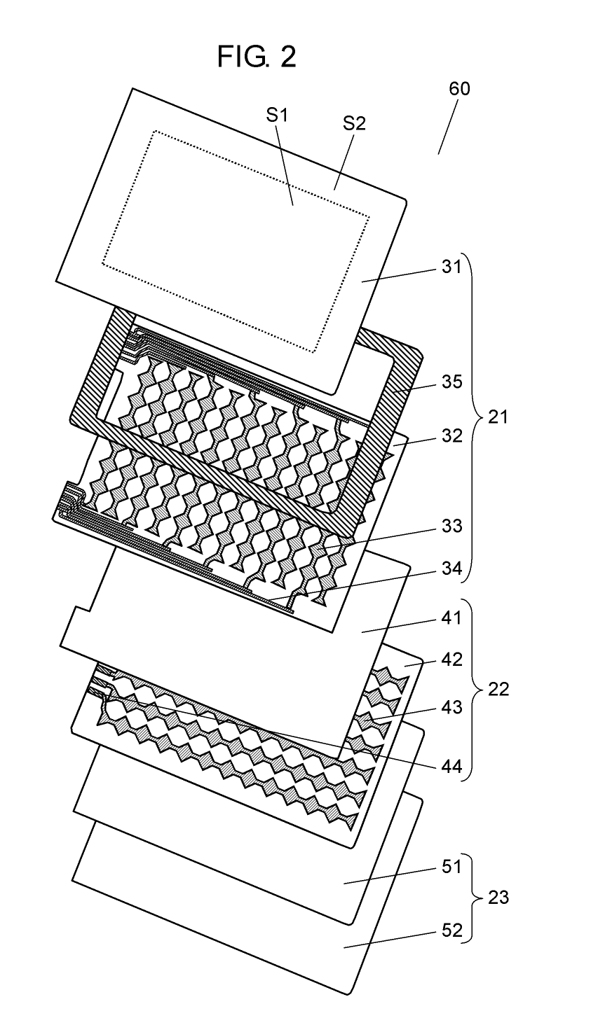

FIG. 1 is a sectional view of touch panel 60 in the exemplary embodiment. FIG. 2 is an exploded perspective view of touch panel 60 in the exemplary embodiment.

Touch panel 60 includes first substrate 32, multiple translucent first electrodes 33, multiple first wirings 34, second substrate 42, multiple translucent second electrodes 43, multiple second wirings 44, and light-shielding layer 35. Multiple first electrodes 33 are formed on first substrate 32 in a first direction. Multiple first wirings 34 include first ends connected to respective first electrodes 33 and second ends extending to the edge of first substrate 32. Second substrate 42 is disposed below first substrate 32. Multiple second electrodes 43 are formed on second substrate 42 in a second direction perpendicular to first electrodes 33. Multiple second wirings 44 include first ends connected to respective second electrodes 43 and second ends extending to the edge of second substrate 42. Light-shielding layer 35 is formed on first substrate 32 in a position covering at least a part of first wirings 34 and also corresponding to at least a part of second wirings 44.

Touch panel 60 includes first substrate unit 21, second substrate unit 22, and cover 23. They are stacked in the sequence of cover 23, second substrate unit 22, and first substrate unit 21. In other words, second substrate unit 22 is sandwiched between cover 23 and first substrate unit 21.

First substrate unit 21 includes first adhesion layer 31, first substrate 32, multiple first electrodes 33, multiple first wirings 34, and light-shielding layer 35.

Second substrate unit 22 includes second adhesion layer 41, second substrate 42, multiple second electrodes 43, and multiple second wirings 44.

First substrate 32 and second substrate 42 are configured with a translucent film of polyethylene terephthalate, polyether sulfone, polycarbonate or the like, or a thin glass sheet.

First electrodes 33 and second electrodes 43 are configured with a translucent and conductive material, such as indium tin oxide and tin oxide. First electrodes 33 are formed on the top face of first substrate 32 in an area corresponding to operating area S1, by sputtering or the like, in a predetermined direction (first direction). Second electrodes 43 are formed on the top face of second substrate 42 in an area corresponding to operating area S1, by sputtering or the like, in a direction perpendicular to first electrodes 33 (second direction). Here, operating area S1 is an area that the user operates. First electrodes 33 and second electrodes 43 are mutually insulated.

The first ends of first wirings 34 are connected to first electrodes 33, and the second ends of first wirings 34 extend to the left-hand end of first substrate 32. The first ends of second wirings 44 are connected to second electrodes 43, and the second ends of second wirings 44 extend to the left-hand end of second substrate 42. In other words, multiple first wirings 34 are formed on an edge of substrate 32, and multiple second wirings 44 are formed on an edge of substrate 42. Areas where multiple first wirings 34 and multiple second wirings 44 are formed correspond to non-operating area S2. Here, non-operating area S2 is an area that the user does not operate.

Multiple first wirings 34 and multiple second wirings 44 are made of non-translucent metal, such as copper particles, sliver particles, copper nanoparticles, and silver nanoparticles; and are formed by sputtering, vapor deposition, printing or the like.

First wirings 34 are connected to a flexible printed circuit board (not illustrated) at the left-hand end of first substrate 32. Second wirings 44 are also connected to the flexible printed circuit board at the left-hand end of second substrate 42.

Light-shielding layer 35 is configured by printing a non-translucent insulating material, such as colored ink. Light-shielding layer 35 has a frame-like or belt-like shape when seen from the top, and is disposed over positions corresponding to multiple first wirings 34 and multiple second wirings 44. Here, light-shielding layer 35 is formed on first substrate 32 to cover multiple first wirings 34. Light-shielding layer 35 may be formed using a method other than printing. For example, light-shielding layer 35 may be formed by overlaying a non-translucent insulating film.

Since light-shielding layer 35 conceals first wirings 34 and second wirings 44, it becomes difficult for the user to see first wirings 34 and second wirings 44. In addition, light-shielding layer 35 prevents entry of moisture into first wirings 34, suppressing corrosion of first wirings 34.

In touch panel 60, an area inside the frame of light-shielding layer 35 is operating area S1. First electrodes 33 and second electrodes 43 are disposed in this area. An area where light-shielding layer 35 is formed is non-operating area S2. First electrodes 33 and second electrodes 43 are not disposed in this area.

First adhesion layer 31 and second adhesion layer 41 are configured with acrylic or silicone adhesive material or the like. Second adhesion layer 41 bonds first substrate 21 and second substrate 22. First adhesion layer 31 covers the top face of light-shielding layer 35 and the top faces of first substrate 32 and first electrodes 33 that are exposed inside the frame of light-shielding layer 35.

Cover 23 is configured with third adhesion layer 51 and cover layer 52. Cover layer 52 is configured by forming a translucent film of polyethylene terephthalate, polyether sulfone, polycarbonate or the like, or a protective film on the bottom face of the thin glass sheet. Third adhesion layer 51 is configured with an acrylic or silicone adhesive material or the like. Third adhesion layer 51 is disposed on the top face of cover layer 52 to bond second substrate 42 and cover layer 52.

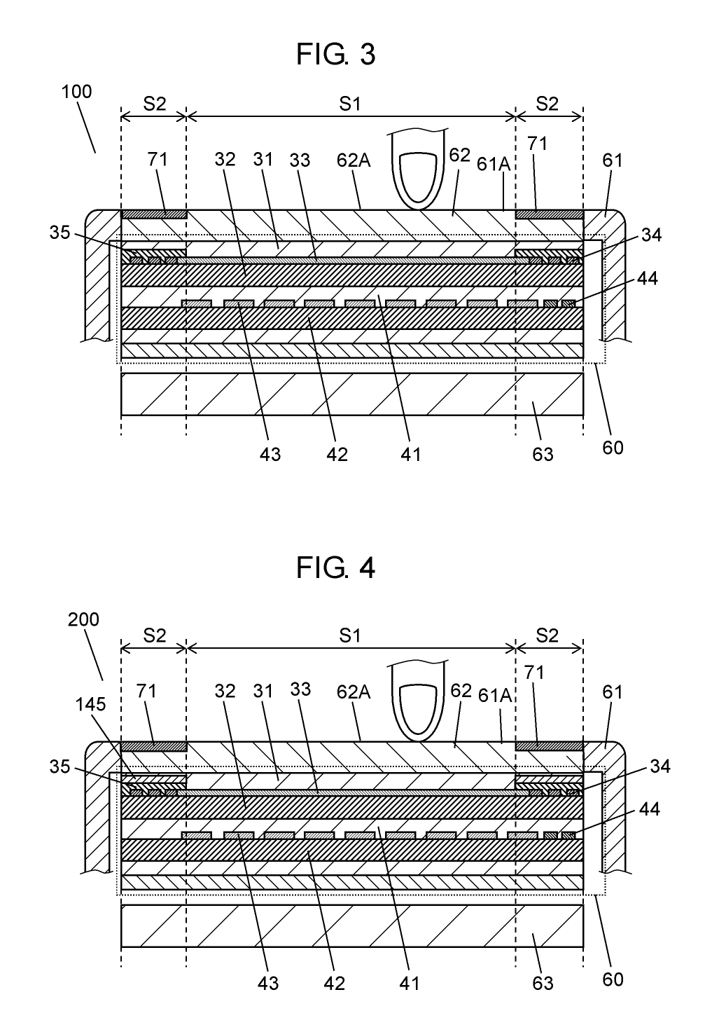

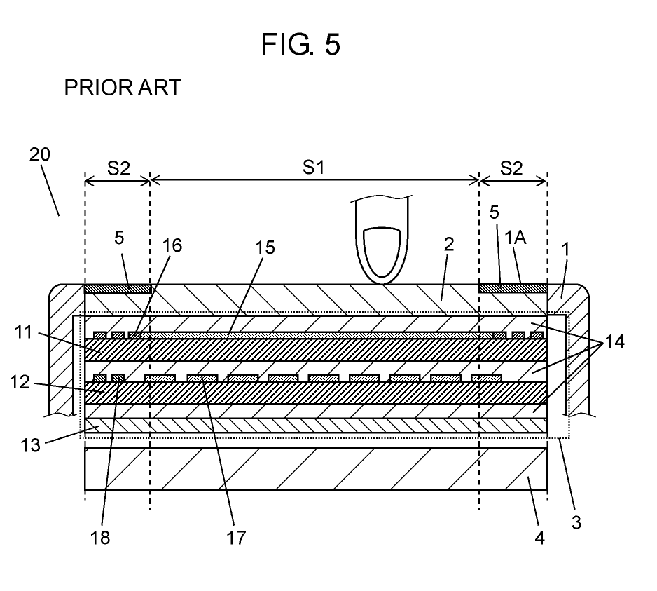

FIG. 3 is a sectional view of input device 100 employing touch panel 60 in the exemplary embodiment. Transparent plate 62 made of insulating resin or glass is fixed in opening 61A at the top face of insulating resin casing 61. Decorative layer 71 is disposed at the side of operating face 62A of transparent plate 62 in non-operating area S2 that is outside operating area S1. Touch panel 60 is bonded to the bottom face of transparent plate 62 by first adhesion layer 31.

Display device 63 is a display element such as a liquid crystal display. Display device 63 is disposed such that touch panel 60 comes to the side of display face. First electrodes 33 and second electrodes 43 of touch panel 60 and display device 63 are connected to an electronic circuit (not illustrated) of input device 100 via connectors and lead wires (not illustrated).

In the above structure, voltage is applied between first electrodes 33 and second electrodes 43 from the electronic circuit to generate the electric field between first electrodes 33 and second electrodes 43. In this state, the user touches the top face of transparent plate 62 with a finger or dedicated pen, according to what is displayed on display device 63 on the rear face of touch panel 60. Then, electrostatic capacitance between first electrode 33 and second electrode 43 at a position operated changes. The electronic circuit detects the position operated based on this change, and thus diversifying functions of input device 100 can be switched.

For example, if the user touches the top face of transparent plate 62 over a predetermined menu in the state multiple menus are displayed on display device 63, the electrostatic capacitance between first electrode 33 and second electrode 43 at a position operated changes. The electronic circuit detects this change, and thus the menu is selected.

Decorative layer 71 disposed at the side of operating face 62A of transparent plate 62 and light-shielding layer 35 of touch panel 60 preferably have the same color (same hue). The use of the same hue for decorative layer 71 and light-shielding layer 35 makes it difficult for the user to distinguish between decorative layer 71 and light-shielding layer 35. Accordingly, the appearance of input device 100 improves.

FIG. 4 is a sectional view of input device 200 using another touch panel in the exemplary embodiment. Conductive layer 145 is provided on light-shielding layer 35. Conductive layer 145 is configured with a thin metal plate, and is disposed over first wirings 34 and second wirings 44. Conductive layer 145 is formed by carbon-printing, transfer of conductive resin, sputtering of color metal or the like. Conductive layer 145 suppresses radiation of electromagnetic noise produced in first wirings 34 and second wirings 44 to outside input device 200 or to the electronic circuit inside input device 200. In addition, electromagnetic noise from an outside of input device 200 to an inside of input device 200 is suppressed by conductive layer 145. Accordingly, the effect of electromagnetic noise from input device 200 on other electronic apparatuses or the effect on input device 200 for electromagnetic noise from the outside can be suppressed, and also reliability of input operation of input device 200 improves. Conductive layer 145 may be formed on a part of light-shielding layer 35, instead of the entire layer.

Furthermore, decorative layer 71 and conductive layer 145 preferably have the same color (same hue). The use of the same hue for decorative layer 71 and conductive layer 145 makes it difficult for the user to recognize the presence of conductive layer 145. Accordingly, the appearance of input device 200 improves.

Light-shielding layer 35 may protrude inward to operating area S1. In this case, a predetermined control is executed when the user touches over an inner rim of light-shielding layer 35 or over light-shielding layer 35 inside operating area S1. If light-shielding layer 35 protrudes inward to operating area S1, an icon for indicating an operating position may be provided on light-shielding layer 35, by printing or the like.

Still more, operating face 62A of transparent plate 62 may be curved. If the operating face is curved in conventional input device 20, underneath non-operating area S2 becomes more visible to the user, even if decorative layer 5 is disposed on the bottom face of transparent plate 2. However, in the exemplary embodiment, light-shielding layer 35 can conceal first wirings 34 and second wirings 44.

Still more, shapes of first electrodes 33 and second electrodes 43 are not limited to a so-called diamond pattern that is successive diamond shapes. Squares may be adopted. Still more, first electrodes 33 and second electrodes 43 may be disposed in an insulated state on the top face of first substrate 32 without providing second substrate 42 and second adhesion layer 41.

Furthermore, part of first wirings 34 and second wirings 44 may be disposed in operating area S1. In this case, portions of first wirings 34 and second wirings 44 disposed in operating area S1 are configured with translucent metal, and portions disposed in non-operating area S2 are configured with non-translucent metal.

As described above, the exemplary embodiment makes the user difficult to see first wirings 34 and second wirings 44 by forming non-translucent light-shielding layer 35. Accordingly, touch panel 60 with good appearance can be achieved.

Still more, electromagnetic noise produced in first wirings 34 and second wirings 44 can be reduced by forming conductive layer 145 over light-shielding layer 35 to cover light-shielding layer 35.

Still more, light-shielding layer 35 becomes less visible to the user by forming decorative layer 71 on transparent plate 62 using the same color (same hue) as light-shielding layer 35. Accordingly, input device 100 with even better appearance can be achieved.

Still more, light-shielding layer 35 conceals first wirings 34 and second wirings 44 such that light-shielding layer 35 is close to first wirings 34 and second wirings 44, compared to that of conventional input device 20. Accordingly, the width of decorative layer 71 can be further narrowed. Alternatively, the display area of display device 63 can be further broadened. Or, if the display area stays the same, the input device can be further downsized.

Furthermore, conductive layer 145 becomes less visible to the user by using the same color (same hue) for decorative layer 71 and conductive layer 145. Accordingly, input device 200 with even better appearance can be achieved.

The touch panel in the exemplary embodiment has an advantageous effect of improving appearance, and thus it is effectively applied mainly to various input devices.

What is claimed is:

1. A touch panel comprising:
a first substrate;
a plurality of translucent first electrodes formed on the first substrate in a first direction;
a plurality of first wirings, each including a first end connected to each of the plurality of first electrodes and a second end extending to an edge of the first substrate;
a second substrate disposed below the first substrate;
a plurality of translucent second electrodes formed on the second substrate in a second direction perpendicular to the first electrodes;
a plurality of second wirings, each including a first end connected to each of the plurality of second electrodes and a second end extending to an edge of the second substrate; and
a light-shielding layer formed on the first substrate in a position covering at least a part of the first wirings and also corresponding to at least a part of the second wirings.

2. The touch panel of claim 1, further comprising:
a conductive layer formed on at least a part of the light-shielding layer.

3. The touch panel of claim 1,
wherein the light-shielding layer is formed in a frame shape.

4. The touch panel of claim 1,
wherein the plurality of first wirings and the plurality of second wirings are configured with translucent metal and non-translucent metal, and
the light-shielding layer is formed in an area corresponding to the non-translucent metal of the first wirings and the second wirings.

5. An input device comprising:
a transparent plate;
a display device; and
a touch panel disposed between the transparent plate and the display device, the touch panel including:
a first substrate;
a plurality of translucent first electrodes formed on the first substrate in a first direction;
a plurality of first wirings, each including a first end connected to each of the plurality of first electrodes and a second end extending to an edge of the first substrate;
a second substrate disposed below the first substrate;
a plurality of translucent second electrodes formed on the second substrate in a second direction perpendicular to the first electrodes;
a plurality of second wirings, each including a first end connected to each of the plurality of second electrodes and a second end extending to an edge of the second substrate; and
a light-shielding layer formed on the first substrate in a position covering at least a part of the first wirings and also corresponding to at least a part of the second wirings.

6. The input device of claim 5, further comprising:
a decorative layer formed on the transparent plate.

7. The input device of claim 6,
wherein the light-shielding layer and the decorative layer have a same hue.

8. The input device of claim 6, further comprising:
a conductive layer formed on at least a part of the light-shielding layer,
wherein the conductive layer and the decorative layer have a same hue.
